(19) United States
(12) Patent Application Publication
(10) Pub. No.: US 2002/0121952 A1
(43) Pub. Date: Sep. 5, 2002

(54) Self-captivated pushbutton unit for circuit breakers

(76) Inventors: Roger Neil Castonguay, Terryville, CT (US); Girish Mruthunjaya Hassan, Seconderabad (IN); Dean Arthur Robarge, Southington, CT (US)

Correspondence Address: PATENT OPERATION, GENERAL ELECTRIC COMPANY, 41 WOODFORD AVENUE, PLAINVILLE, CT, 06062

(21) Appl. No.: 09/681,243

(22) Filed: Mar. 5, 2001

(51) Int. Cl. H01H 67/02; H01H 9/02

(52) U.S. Cl. 335/132

(57) ABSTRACT

A circuit breaker cover is provided with a spring loaded pushbutton assembly that is self-captivated within the cover, thereby enabling the assembly and operation of the pushbutton unit without the need for additional hardware or fixation devices. The pushbutton unit is pivotally arranged within the cover and spring biased against a stop surface in the cover. A top-down assembled, self-captivated pushbutton unit provides for improved manufacturability of the host device, which may be but is not limited to a standard circuit breaker, a rotary circuit breaker, a switch, or a disconnect device. Host devices utilizing such pushbutton units are employed in residential, commercial, industrial or utility applications, and may be employed in single device enclosures or in electrical distribution panels.

### FIELD OF THE INVENTION

The present invention relates generally to a pushbutton assembly for actuating a trip mechanism of an electrical disconnect device, and, more particularly, to a pushbutton assembly for a circuit breaker where the pushbutton assembly is spring biased and self-captivated within the circuit breaker cover.

### BACKGROUND OF THE INVENTION

Pushbutton devices have the general function of providing an interface for the purpose of actuating an auxiliary system behind a panel front. One such auxiliary system is the trip system of a circuit breaker, and one such panel front is a circuit breaker cover. As the push surface of the pushbutton is depressed, a drive surface on the pushbutton is set in motion to produce work. In the instance of a circuit breaker, the work produced results in the tripping of the trip system, or trip latch, and subsequent opening of the circuit breaker contacts, thereby disconnecting the protected circuit from the power source.

Pushbutton devices can be employed in many types of electrical disconnect devices, such as, but not limited to; conventional circuit breakers, current limiting circuit breakers, rotary circuit breakers, and disconnect switches. However, pushbutton devices are not limited to circuit breakers, but can also be employed in other systems, such as; control devices, pilot lights, sensors, and auxiliary switches. The industries that pushbuttons can be used in are varied, and include, but are not limited to, the utility, industrial, commercial, residential, and automotive industries.

Trip test buttons for circuit breakers include “twist to trip”, “slide to trip”, and “push to trip” arrangements. U.S. Pat. No. 3,671,890 entitled “Manually Operable Molded Case Circuit Breaker With Special Trip Testing Means” describes a “twist to trip” arrangement. U.S. Pat. No. 4,740,768 entitled “Manual Trip Operator for Molded Case Circuit Breaker” describes a “slide to trip” arrangement. However, for ease of actuation, some applications require the use of a “push to trip” arrangement. U.S. Pat. No. 4,982,173 entitled “Rotatable Trip Test Assembly For Molded Case Circuit Breakers” describes a “push to trip” arrangement incorporating a pushbutton device for use in a circuit breaker that includes a reset spring that is molded integrally with the pushbutton unit. The described pushbutton device is captivated between the circuit breaker cover and auxiliary cover by a ball and socket arrangement, where half of the socket is defined by the circuit breaker cover and the other half by the auxiliary cover. Removal of the auxiliary cover from the circuit breaker cover disturbs the captivation arrangement.

It would be beneficial to provide a pushbutton device in a “push to trip” arrangement that is easy to actuate and is self captivated in the circuit breaker cover so that removal of an auxiliary cover does not disturb the captivation arrangement.

### SUMMARY OF INVENTION

In an exemplary embodiment of the present invention, a pushbutton assembly is self-captivated in a circuit breaker cover, or midcover, thereby enabling the cover or midcover to be removed without disturbing the captivation of the pushbutton unit. Whether the cover or midcover is in place or not, the self-captivated pushbutton is completely operable and can actuate the trip latch components of the circuit breaker operating mechanism. The pushbutton assembly includes a pushbutton unit and a reset spring. The pushbutton unit is pivotally arranged within the circuit breaker midcover, and is held in a self-captivated arrangement with the circuit breaker midcover by the action of the two end legs of the reset spring. One leg of the reset spring is captivated by the circuit breaker midcover, and the other by the pushbutton unit, thereby resulting in a bias force that securely captivates the pushbutton unit in the midcover. A drive surface at the end of an extension leg on the pushbutton unit provides the means for actuating a trip system, and a stop arm on the pushbutton unit interacts with a stop surface on the circuit breaker midcover to limit the reset motion of the pushbutton under the bias of the reset spring. The moment arm of the pivotally arranged pushbutton offers a mechanical advantage not available with linearly actuated arrangements.The pushbutton unit can be fabricated from any material suitable for the application, such as, but not limited to; polyethylene, polypropylene, polystyrene, polyester, polyvinyl chloride, acrylics, nylons, spandex-type polyurethanes, polyamides, polycarbonates, fluorocarbons, cellulosics, or other thermoplastic plastics, or similar such materials.

The pushbutton device of the present invention has the functional characteristics of “push” actuation, pivotal motion, linear or rotary resultant action, and self-captivation. As described, the pushbutton device can be employed in electrical disconnect devices, such as, for example, safety switches, and conventional and rotary circuit breakers, and the distribution equipment that such disconnect devices are employed in.

### BRIEF DESCRIPTION OF DRAWINGS

FIG. 1 illustrates a perspective view of an electrical distribution panel incorporating the present invention;

FIG. 2 illustrates a perspective view of an electrical circuit breaker incorporating the present invention;

FIG. 3 illustrates an exploded perspective view of the electrical circuit breaker of FIG. 2 with the circuit breaker covers removed;

FIG. 4 illustrates a cutaway side view of the electrical circuit breaker of FIG. 2 showing the internal electrical components;

FIG. 5 illustrates an exploded perspective view of a circuit breaker midcover and a pushbutton device;

FIG. 6 illustrates a partial perspective view of the circuit breaker midcover and pushbutton device of FIG. 5 in a partially assembled state;

FIG. 7 illustrates a partial perspective view of the circuit breaker midcover and pushbutton device of FIG. 5 in a fully assembled state;

FIG. 8 illustrates a partial perspective view of the circuit breaker midcover and pushbutton device of FIG. 5 in a fully assembled and actuated state;

FIG. 9 illustrates a partial side view of the circuit breaker midcover and pushbutton device of FIG. 5 in a quiescent state; and

FIG. 10 illustrates a partial side view of the circuit breaker midcover and pushbutton device of FIG. 5 in an actuated state.

### DETAILED DESCRIPTION

Distribution Panel Generally

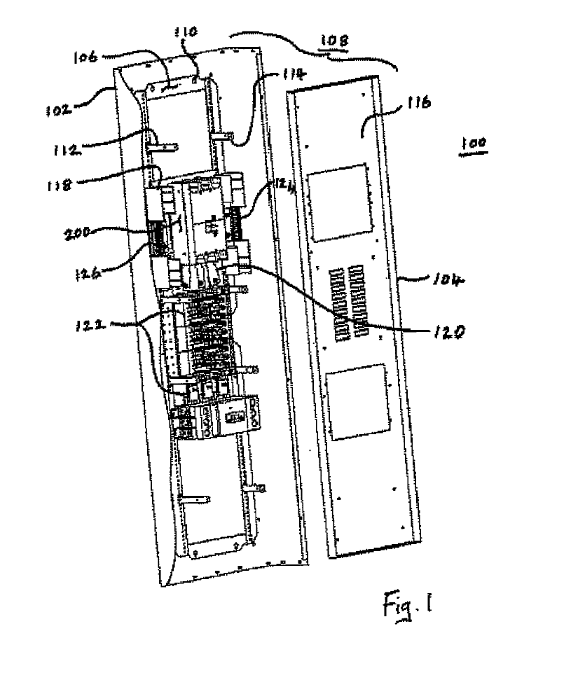

An electrical distribution panel, well known to one skilled in the art of electrical distribution, is depicted generally in FIG. 1, is fully described in commonly assigned U.S. patent application Ser. No. 09/560,226 entitled “Electrical Distribution Panel With Split Neutral Bus” filed Apr. 28, 2000, functions generally to distribute protected power from a common main source to a plurality of branch circuits, and is described generally below.

Referring to FIG. 1, an electrical distribution panel 100 includes a panel base 102, a panel cover 104 and an interior assembly 106. The panel base 102 and panel cover 104 generally make up the panel housing 108 of distribution panel 100. The interior assembly 106 is attached to panel base 102 by suitable fasteners, not shown, through mounting holes 110. Upstanding supports 112 are integral to interior assembly 106 and provide attachment surfaces 114 for attachment of panel cover 104, which is secured to the attachment surfaces 114 by suitable fasteners, not shown, through holes 116 in panel cover 104.

Interior assembly 106 includes main support 118 for mechanically supporting a main circuit device, such as but not limited to a circuit breaker 200 that is fully described below, at least one busbar 120 for connecting circuit breaker 200 to a plurality of branch circuit connections 122, a ground connector 124 for providing an electrical ground connection within the distribution panel 100, and a neutral connector 126 for providing an electrical neutral connection within the distribution panel 100. Power distribution to a plurality of branch circuits, not shown, is made through the plurality of branch circuit connections 122.

Circuit Breaker Overview

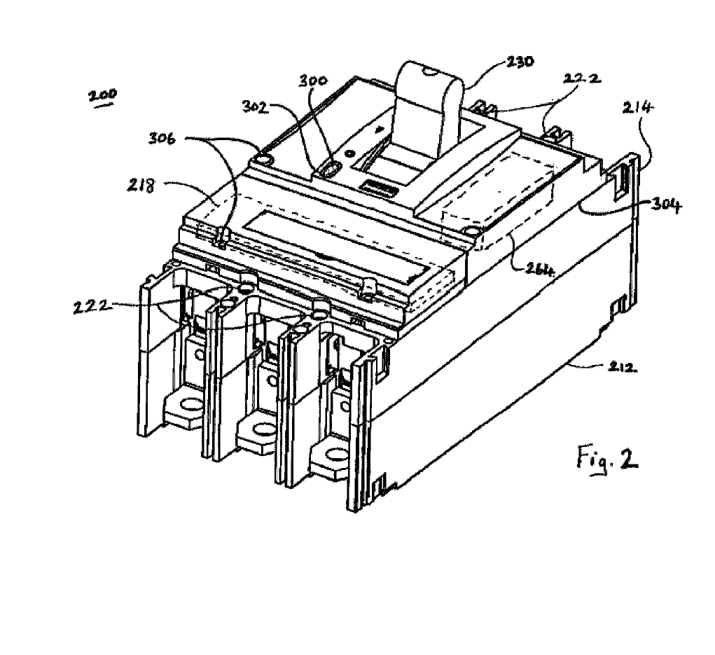

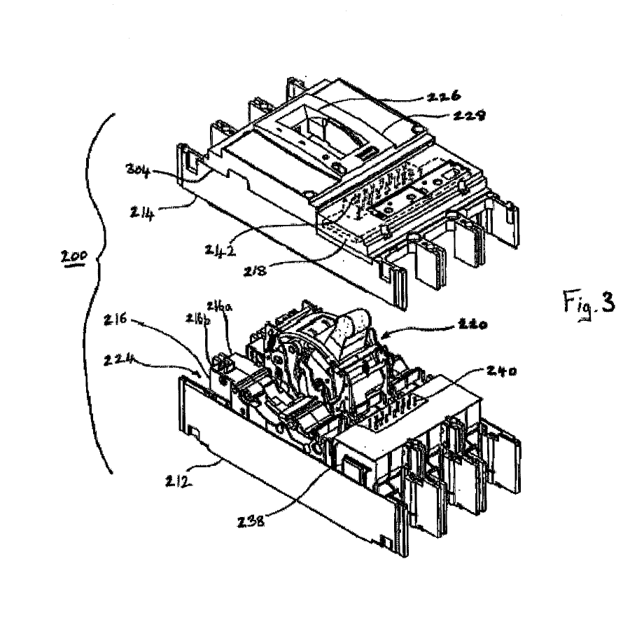

A circuit breaker 200 incorporating the present invention is depicted in the perspective view of FIG. 2 and the exploded view of FIG. 3. Base 212 and midcover 214 captivate cassette 216, trip unit 218 and operating mechanism 220 by fasteners, not shown, through holes 222. Cassette halves 216a,b are secured by fasteners, not shown, and are positionally located in pocket 224 of base 212. Pushbutton 300 extends through opening 302 of top cover 304 and is described in more detail below. Top cover 304 is secured to midcover 214 by fasteners, not shown, through holes 306.

For simplicity and clarity, where more than one element of the same type is present, only one will be referenced, but the reader will readily recognize that the single reference pertains to more than one element of the same type. Here, for example, there are three cassettes 216 and three pockets 224. Each cassette 216 is positionally located in an associated pocket 224. Reference is made to a cassette 216 and a pocket 224, but the reader will readily recognize that three cassettes 216 and three pockets 224 are present. Also for simplicity and clarity, reference will only be made to a three phase circuit breaker, but the reader will recognize that the present invention is equally applicable to single phase, two phase or multi-phase electrical switching devices of any kind.

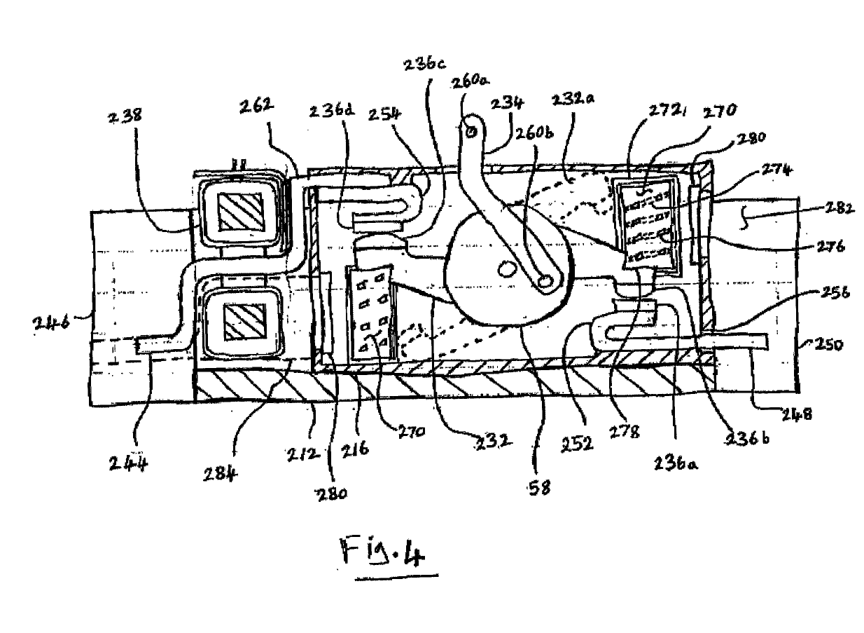

Extending through opening 226 of escutcheon 228 on midcover 214 is operating handle 230, which is operatively connected to movable contact arm 232 by operating mechanism 220 and link 234, best seen by referring to FIG. 4. Handle 230 enables the opening and closing of electrical contacts 236a,b,c,d, best seen by referring to FIG. 4.

Operating mechanism 220 is of a type well known to one skilled in the art. An example of such an operating mechanism is depicted generally in FIG. 3, is fully described in commonly assigned U.S. patent application Ser. No. 09/516,475 entitled “Circuit Interrupter Operating Mechanism” filed Mar. 1, 2000, and functions generally to open and close electrical contacts 236a,b,c,d by actuation of operating handle 230.

Trip unit 218 is of a type well known to one skilled in the art and is depicted generally in FIGS. 2 and 3. An example of such a trip unit is fully described in commonly assigned U.S. Pat. Nos. 4,589,052, 4,728,914, and 4,833,563, and functions generally to initiate a trip action within the actuator 264 after receiving a trip signal from current sensors 238.

Trip unit 218 is operatively connected to current sensors 238 by pins 240 and sockets 242, and to operating mechanism 220 by actuator 264, shown in phantom in FIG. 2, to effectuate the opening of contacts 236a,b,c,d upon the occurrence of an abnormal overcurrent condition.

An example of an actuator 264 is shown generally in phantom in FIG. 2, is fully described in commonly assigned U.S. patent application Ser. No. 09/518,899 entitled “Fast Acting High Force Trip Actuator” filed Mar. 6, 2000, and functions generally to transfer the trip action to the operating mechanism 220 after receiving a trip signal from the trip unit 218.

Current sensor and current transformer 238 is shown generally in FIGS. 3 and 4 and is well known to one skilled in the art of current sensing. A representative example of such a current sensor and current transformer 238 is fully described in commonly assigned U.S. Pat. Nos. 4,589,052, 4,728,914, and 4,833,563, and functions generally to power up trip unit 218 and provide trip unit 218 with a signal representative of the circuit current in the protected circuit.

Referring to FIG. 4, which depicts a cutaway side view of cassette 216 and current sensor 238 in base 212, electrical connections between the protected circuit, not shown, and circuit breaker 200 are made through load terminal 244 on load side 246 of circuit breaker 200. Electrical connections between the power source, not shown, and circuit breaker 200 are made through line terminal 248 on line side 250 of circuit breaker 200.

Referring to FIGS. 2, 3 and 4, circuit breaker 200 includes operating handle 230 for driving operating mechanism 220 to manually open and close electrical contacts 236a,b,c,d. Contact 236a is carried by elongated fixed contact arm 252, contacts 236b,c are carried by elongated movable contact arm 232, and contact 236d is carried by elongated fixed contact arm 254. FIG. 4 also shows movable contact arm 232a, depicted in phantom, following an opening action by trip unit 218 and operating mechanism 220. Fixed contact arm 252 extends through opening 256 of cassette 216 to terminate in line terminal 248, which is accessible through an opening, not shown, in line side 250 of base 212. Obviously, each phase of the multi-phase circuit breaker would have separate conductors per phase, not shown. Operating mechanism 220 is operatively connected to contact arm 232 by link 234, rotor 258, and connecting pins 260a,b.

The current path through circuit breaker 200 in the closed position is best seen by referring to FIG. 4. Under quiescent operating conditions, the current from the power source enters circuit breaker 200 through line terminal 248 (and other line terminals on adjacent phases not shown), and exits through load terminal 244 (and other load terminals on adjacent phases not shown). Between line terminal 248, and load terminal 244, the current path consists of; fixed contact arm 252, electrical contacts 236a and b, movable contact arm 232, electrical contacts 236c and d, fixed contact arm 254, and sensor strap 262. Sensor strap 262 passes through and provides primary current signal to current sensor 238, which is operatively connected to trip unit 218 by pins 240 and sockets 242. Fixed contact arm 254 is mechanically and electrically connected to sensor strap 262 by a fastener, not shown. Sensor strap 262 passes through current sensor 238 to terminate in load terminal 244, which is accessible through an opening, not shown, in load side 246 of base 212.Arc chute, or arc extinguishing assembly 270, is removably captivated within cassette 216 by molded detail 272 that is integral to cassette 216. Arc plates 274, are typically, but not necessarily, arranged substantially parallel to one another, have tabs 276 that are captivated in corresponding slots in plate supports 278. Exhaust baffle 280 is removably captivated within cassette 216 by molded slot, not shown, that is integral to cassette 216. Holes in exhaust baffle 280, not shown, provide for the passage of arc effluent generated from a short circuit interruption condition. The arc effluent passing through exhaust baffle 280 on line side 250 of circuit breaker 200 will exit base 212 through terminal chamber 282. The arc effluent passing through exhaust baffle 280 on load side 246 of circuit breaker 200 will exit base 212 through vent channel 284, shown in phantom in FIG. 4.

Vent channels 284 are shown generally in phantom in FIG. 4, are fully described in commonly assigned U.S. patent application Ser. No. 09/366,473 entitled “Bottom Vented Circuit Breaker Capable of Top Down Assembly Onto Equipment” filed Aug. 3, 1999, and function generally to provide a passage for the arc effluent to travel from the inside of cassette 216 to the outside of circuit breaker 200 during an abnormal overcurrent condition.

Pushbutton Assembly

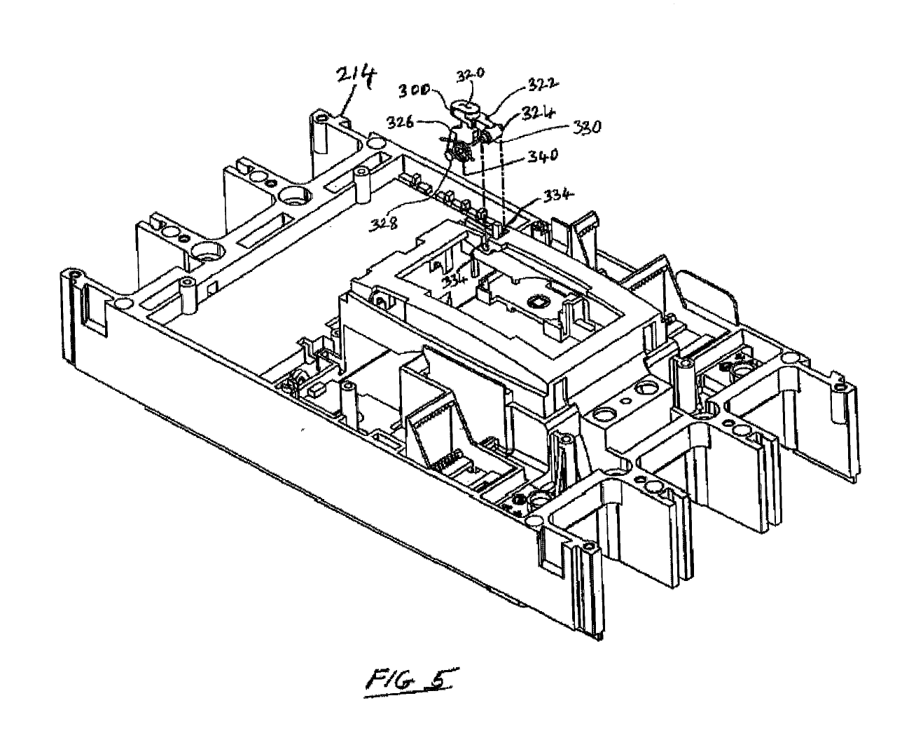

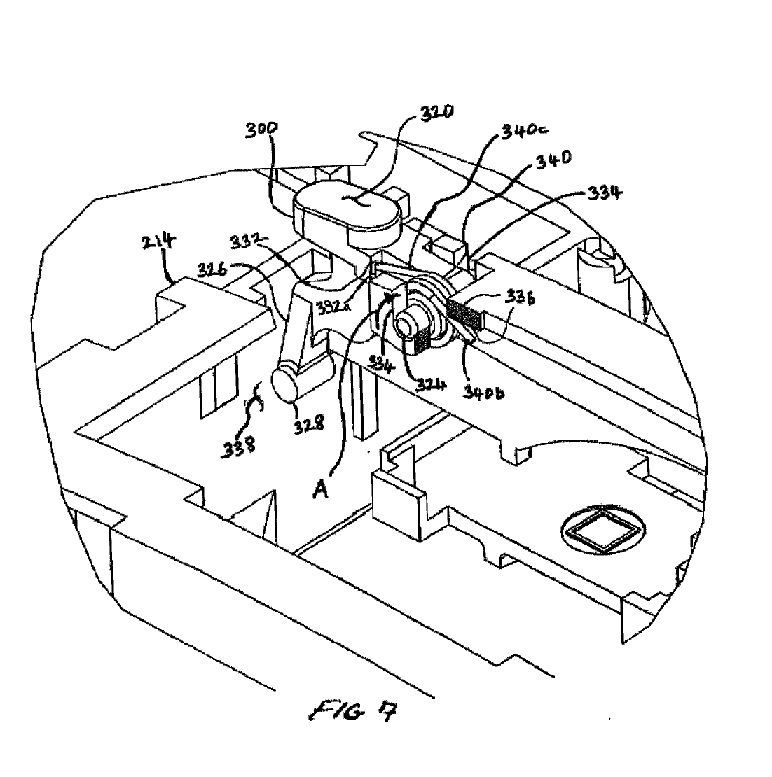

Referring to FIGS. 5, 6, and 7, pushbutton unit 300 includes a push surface 320, a first leg 322 with a pivot 324 disposed at the end thereof, a second leg 326 with a drive surface 328 disposed at the end thereof, a support arm 330 concentric with pivot 324, and an engagement surface 332. Alternatively, pushbutton unit 300 may have an engagement surface 332 with a side wall 332a. Reset spring 340 includes a spring body 340a, a first spring leg 340b, and a second spring leg 340c. Midcover 214 includes a pivot pocket 334, an engagement surface, or bridging wall, 336, and a stop surface, or restraining wall, 338.

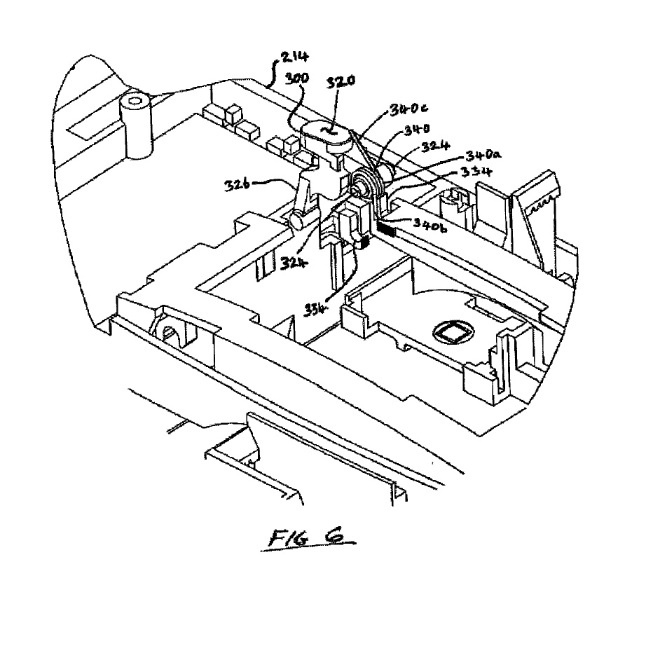

The assembly of pushbutton unit 300 and reset spring 340 to midcover 214 is accomplished by first placing spring body 340a over support arm 330 and rotating reset spring 340 to orient first and second spring legs 340b and c as shown in FIG. 6. The pushbutton assembly of pushbutton unit 300 and reset spring 340 is next assembled to midcover 214 by inserting pivots 324 into pivot pockets 334 while hooking first spring leg 340b under engagement surface 336 of midcover 214. Second spring leg 340c is then hooked under engagement surface 332 of pushbutton unit 300 to complete the captivation of reset spring 340. Allowing pushbutton unit 300 to rotate under the bias of reset spring 340 results in pushbutton unit 300 rotating in a clockwise direction (a first direction), illustrated by arrow A, until the end of second leg 326 of pushbutton unit 300 engages stop surface 338 of midcover 214. In the assembled condition, or quiescent condition, the bias force of reset spring 340 serves to self-captivate pushbutton unit 300 in midcover 214.

Alternative Embodiment of Pushbutton Assembly

The above described pushbutton assembly includes a pushbutton unit 300 and a reset spring 340. However, reset spring 340 may also be made integral with pushbutton unit 300, thereby providing a unitary pushbutton and spring arrangement that is self-captivated within the midcover 214. Selection of a suitable thermoplastic material, such as from the list provided above, will enable such an integral pushbutton arrangement to function as a resettable pushbutton, and in accordance with the teachings of the present invention be self-captivating.

Pushbutton Operation

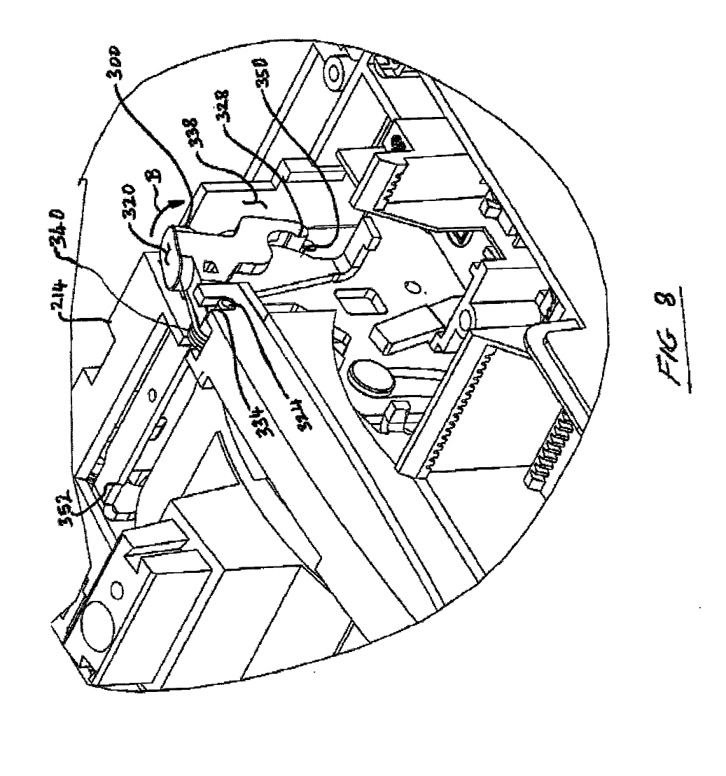

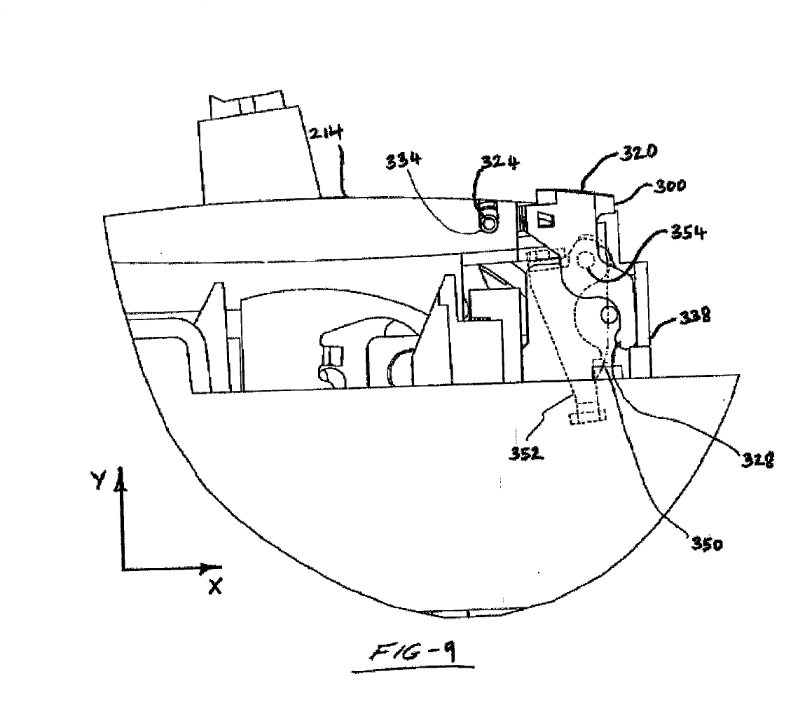

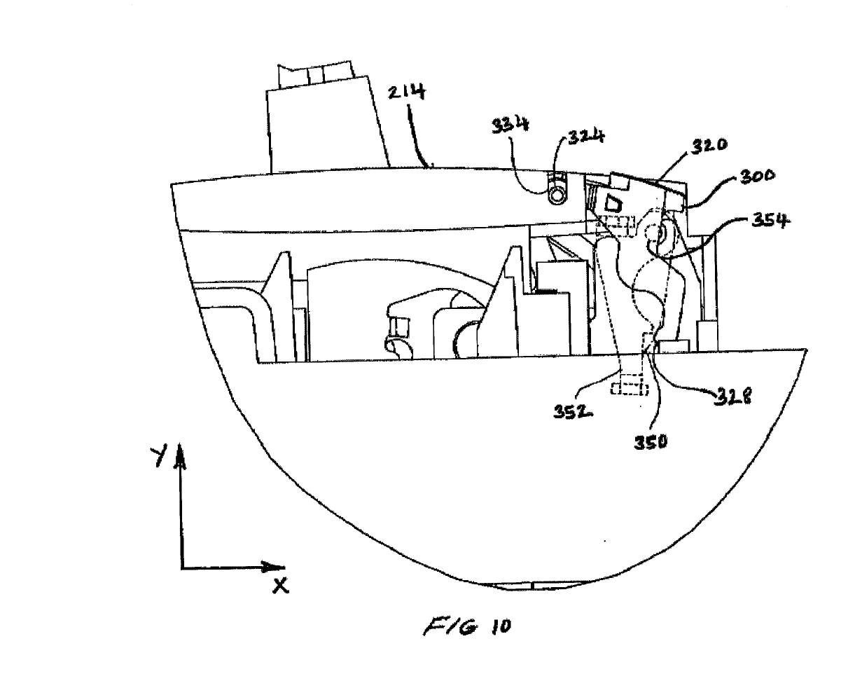

Referring to FIGS. 8, 9, and 10, pushing on push surface 320 of pushbutton unit 300 rotates pushbutton unit 300 in a clockwise direction (a second direction) about pivot 324, illustrated by arrow B, in opposition to the bias force of reset spring 340. As pushbutton unit 300 continues to rotate clockwise about pivot 324, drive surface 328 engages outer leg 350 of trip latch 352 to rotate trip latch 352 clockwise about latch pivot 354, as shown in FIG. 10. Rotation of trip latch 352 serves to trip operating mechanism 220, thereby resulting in the separation of contacts 236a-d to disconnect the protected circuit as discussed above. Release of pushbutton unit 300 allows pushbutton unit 300 to return to its quiescent position under the bias force of reset spring 340, as shown in FIG. 9. Throughout the clockwise and return counterclockwise motion of pushbutton unit 300, pushbutton unit 300 remains self-captivated in midcover 214 whether top cover 304 is attached or not.

Alternative Embodiment of Pushbutton Action

The above described action of pushbutton unit 300 results in rotational motion of trip latch 352. However, it will be appreciated that the scope of the present invention also encompasses translational motion of a trip latch (or other driven member). Since drive surface 328 of pushbutton unit 300 rotates in a clockwise direction about pivot 324 when push surface 320 is pushed, see FIG. 10, it has motion in both the negative-X and negative-Y directions, see FIGS. 9 and 10 for sign convention. Thus, by incorporating an appropriate cam surface on a trip latch (or other driven member), either rotational or translational motion of the trip latch can result, and the decision to use one or the other arrangements is simply a matter of design choice.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A support housing and pushbutton assembly, comprising:
a support housing;
a pushbutton unit pivotally arranged within said support housing and capable of moving in a first direction and a second direction;
a reset spring for biasing said pushbutton unit in said first direction;
wherein
said pushbutton unit and said reset spring are self-captivated within said support housing.

2. The support housing and pushbutton assembly of claim 1, wherein;
said reset spring has a spring body and first and second legs;
wherein said pushbutton unit has a support arm for supporting said spring body;
wherein said support housing has a first surface for engaging said first leg of said reset spring;
wherein said pushbutton unit has a second surface for engaging said second leg of said reset spring;
wherein said support housing has a stop surface for restricting motion of said pushbutton unit in said first direction; and
wherein said pushbutton unit has a stop arm for engaging said stop surface when said pushbutton unit moves in said first direction.

3. The support housing and pushbutton assembly of claim 2, wherein;
said second surface on said pushbutton unit is intermediate said stop arm and pivot of said pivotally arranged pushbutton unit.

4. The support housing and pushbutton assembly of claim 1, wherein;
said reset spring is integral with said pushbutton unit.

5. The support housing and pushbutton assembly of claim 1, further comprising:
at least one trunnion integral with said pushbutton unit for pivotally arranging said pushbutton unit within said support housing; and
at least one pocket integral with said support housing for pivotally supporting said trunnion of said pushbutton unit.

6. The support housing and pushbutton assembly of claim 2, wherein said pushbutton unit further comprises;
a third surface proximate said second surface for restricting lateral movement of said second leg of said reset spring.

7. A cover for an electrical disconnect device comprising:
a pushbutton unit pivotally arranged within said cover and capable of moving in a first direction and a second direction;
a reset spring for biasing said pushbutton unit in said first direction;
wherein
said pushbutton unit and said reset spring are self-captivated within said cover.

8. The cover of claim 7, wherein;
said reset spring has a spring body and first and second legs;
wherein said pushbutton unit has a support arm for supporting said spring body;
wherein said cover has a first surface for engaging said first leg of said reset spring;
wherein said pushbutton unit has a second surface for engaging said second leg of said reset spring;
wherein said cover has a stop surface for restricting motion of said pushbutton unit in said first direction; and
wherein said pushbutton unit has a stop arm for engaging said stop surface on said cover when said pushbutton unit moves in said first direction.

9. A circuit breaker comprising:
a circuit breaker case and cover;
at least one current path within said case;
wherein said current path comprises at least one pair of contacts;
an operating mechanism for closing and opening said contacts;
a pushbutton unit pivotally arranged within said cover and capable of moving in a first direction and a second direction;
a reset spring for biasing said pushbutton unit in said first direction;
wherein said pushbutton unit and said reset spring are self-captivated in said cover; and
wherein said pushbutton unit is coupled to said mechanism for actuating said mechanism.

10. The circuit breaker of claim 9, wherein;
said reset spring has a spring body and first and second legs;
wherein said pushbutton unit has a support arm for supporting said spring body;
wherein said cover has a first surface for engaging said first leg of said reset spring;
wherein said pushbutton unit has a second surface for engaging said second leg of said reset spring;
wherein said cover has a stop surface for restricting motion of said pushbutton unit in said first direction; and
wherein said pushbutton unit has a stop arm for engaging said stop surface on said cover when said pushbutton unit moves in said first direction.

11. An electrical distribution panel, comprising:
a circuit breaker for connecting and disconnecting a protected circuit;
a main support for supporting said circuit breaker;
a plurality of branch circuit connections for connecting to a plurality of branch circuits;
at least one busbar for electrically connecting said circuit breaker to said plurality of branch circuit connections;
a ground connector for providing an electrical ground connection;
a neutral connector for providing an electrical neutral connection;
a panel base for supporting said main support and said plurality of branch circuit connections;
a panel cover coupled to said panel base; wherein said circuit breaker comprises;
a circuit breaker case and cover,
at least one current path within said case,
wherein said current path comprises at least one pair of contacts,
an operating mechanism for closing and opening said contacts,
a pushbutton unit pivotally arranged within said circuit breaker cover and capable of moving in a first direction and a second direction,
a reset spring for biasing said pushbutton unit in said first direction,
wherein said pushbutton unit and said reset spring are self-captivated within said circuit breaker cover, and
wherein said pushbutton unist is coupled to said mechanism for actuating said mechanism.

12. A method for assembling a self-captivating pushbutton unit into a support housing, comprising the steps of;
selecting a support housing having a first surface and at least one pivot pocket;
selecting a pushbutton unit having a second surface and at least one pivot;
selecting a reset spring having first and second legs;
assembling said reset spring onto said pushbutton unit;
engaging said first leg of said reset spring with said first surface of said support housing;
assembling said pivot of said pushbutton unit into said pivot pocket of said support housing;
engaging said second leg of said reset spring with said second surface of said pushbutton unit; and
removing contact with said pushbutton unit to allow said reset spring to self-captivate said pushbutton unit within said support housing.

13. A pushbutton arrangement comprising;
a housing;
a pushbutton unit pivotally arranged within said housing;
a means for self-captivating said pushbutton unit within said housing; and
a means for biasing said pushbutton unit in a first direction.

14. The pushbutton arrangement of claim 13, wherein said biasing means comprises;
a torsion spring having first and second legs;
wherein said first leg engages said support housing; and
wherein second leg engages said pushbutton unit.
